(19) United States
(12) Patent Application Publication
(10) Pub. No.: US 2002/0082028 A1
(43) Pub. Date: Jun. 27, 2002

(54) Paging and selective call routing in a telecommunication environment

(76) Inventor: Peter David Forsling Wittenkamp, Los Altos, CA (US)

Correspondence Address: Michael T. Konczal, Navarro IP Law Group, Suite 655, 801 E. Campbell Rd., Richardson, TX, 75081, US

(21) Appl. No.: 09/745,557

(22) Filed: Dec. 22, 2000

(51) Int. Cl. H04M 3/42

(52) U.S. Cl. 455/458; 455/417; 455/459

(57) ABSTRACT

A method for paging and selectively routing calls in a telecommunication environment (10). Voice service nodes (32(a . . . n)) and data service nodes (30(a . . . n)) are related in a telecommunication environment (10). Voice calls are received utilizing the voice capabilities of the telecommunication environment (10). The incoming calls are parked and IP messages (28(a . . . n)) are broadcast using the IP capabilities of the telecommunication environment (10). Input using the IP capabilities of the telecommunication environment (10) is then used in routing of the calls utilizing the voice capabilities of the telecommunication environment (10). The invention can be practiced in a telecommunication environment (10) served by a separate POTS network (12) and IP network (14), or by an IP network (14) alone providing both voice and data services.

### TECHNICAL FIELD

This invention relates in general to call routing in a telecommunication environment and, in particular, to methods and systems for selectively routing calls to individuals served by both telephone network and Internet Protocol (IP) network services. More particularly, the invention relates to methods and systems for paging among nodes in an IP network and selectively routing voice calls to individuals according to responses to the pages.

### BACKGROUND OF THE INVENTION

Many offices today operate in a telecommunication environment provided with both IP data services and traditional voice telephone services. At least two general approaches to providing IP and voice services can be readily identified in the arts. In one common type of telecommunication environment, two essentially autonomous networks coexist. One network, for example a Local Area Network (LAN), Virtual Local Area Network (VLAN), or Wide Area Network (WAN), exclusively provides IP data traffic, and a separate network exclusively provides voice telephone traffic, for example a Plain Old Telephone Service (POTS) network. Under this approach, actual telephone wires may sometimes be shared, but the services are otherwise largely independent.

Telecommunication environments with single networks also exist, providing both IP data service and Voice over IP (VOIP) service with a single IP network, for example in the form of a LAN, VLAN, or WAN. A characteristic common to many telecommunication environments known in the art, including the two types described above, is that they are populated with Personal Computers (PCs) connected in one or more network configurations supporting Internet Protocol (IP).

In a telecommunication environment with autonomous networks, such as a VLAN and POTS, one or more Public Branch Exchanges (PBX) is connected to users with analog or digital handsets placed at work stations and elsewhere in the offices. Often, each employee in such a telecommunication environment is equipped with both a PC and a voice telephone device, although some employees may be equipped with only one or the other. Of course, incoming voice telephone calls are often directed to individuals in such an environment. Generally, an incoming call is answered by a human operator, such as a receptionist or switchboard operator, using a traditional telephone device, such as a POTS. The next step is to place the incoming call in a park position on the PBX during automated or manual attempts to route the call to the called party utilizing the telephone network. In the event the called party is not at a telephone device associated with such called party, the call is often routed to voice mail or a human operator for messaging. In some offices, overhead paging is used where the switchboard operator uses a public address system to announce verbally that a given person has a call waiting on a particular telephone line. The person called may then go to a handset and enter the appropriate key sequence to retrieve the call. Some PBXs known in the art may be connected to a public address system, thus giving anyone on the telephone network the ability to answer and park a call and initiate the overhead paging.

In a telecommunication environment with a single IP network, such as a VLAN with VolP capabilities, for example, an incoming voice call commonly progresses in substantially the same manner as described above. That is, an incoming voice call directed to a particular individual served by the network is received and manually or automatically routed to a voice-capable node associated with that individual. As in the telecommunication environment using POTS, in the event the called individual is not reached at a device associated with the called individual, the call is commonly routed to voice mail or a human operator for messaging. Similar to the dual-network environment, overhead paging may also be used in conjunction with a single-network environment.

A disadvantage of the single-network telecommunication environments is that most service offerings are modeled on the POTS. That is, although VolP replaces the POTS network, the service to the incoming call remains essentially unchanged. As a result, incoming calls can be missed or unanswered due to an inability to route calls to persons or equipment outside the traditional telecommunication environment, or not accessible at an access node of the POTS network. Also, calls may be missed due to errors in messaging, or simply due to caller frustration with the system. Moreover, in some telecommunication environments, an overhead paging system adds additional network components to the office telecommunication environment, requiring a public address system that increases complexity and cost. Other problems exist with overhead paging such as possible language barriers, intrusive noise associated with paging, interference from background noise, lack of privacy, and the requirement that a called party remember particular key sequences in order to retrieve a message or call.

Thus, there is a need for improvements in the efficient and effective use of paging and call routing systems and methods for locating called parties in order to selectively route incoming calls.

### SUMMARY OF THE INVENTION

Disclosed is a system for receiving incoming voice calls received on a a voice network and routing the calls to devices associated with called parties. Upon receipt of an incoming voice call, data network resources are used to send paging messages and accept page responses. The incoming voice call is then routed in network voice resources using page response(s) received via the data network resources.

The system of the invention can be used in telecommunication environments having separate voice and data network service infrastructure, or in integrated voice-data networks.

Methods of utilizing a data terminal to route an incoming voice call in a network supporting both voice and data traffic are disclosed. According to the invention, calls are received into the voice resources of the network and parked prior to routing. Paging messages are broadcast over the data terminals of the network. Responses are received from the data terminals, and the calls are routed over network voice resources accordingly.

The invention may be implemented using a computer program product of machine-readable instructions for automatically recognizing the receipt of a voice call into the voice resources of the network and parking the incoming call for subsequent routing. A paging message is then automatically broadcast over data terminals of the network and data terminal responses to the paging message are processed. The incoming voice call is then routed in network resources according to the responses received from the data terminals.

In general, the present invention achieves numerous technical advantages by automatically using information obtained via the data IP resources of a telecommunication network to guide the routing of voice calls to voice-capable devices in the network.

A specific technical advantage of the present invention is the use of automatic techniques in which an intended call recipient is first located and the call is then routed accordingly.

Another technical advantage of the invention is the use of an IP network to optimize the concurrent use of a traditional voice telephone network.

Further technical advantages are realized by the utilization of data and voice network resources to eliminate the use of overhead paging, thereby eliminating background noise caused by overhead paging, eliminating background-noise interference with paging, avoiding public disclosure of paging message contents, reducing problems with language barriers, and permitting global paging.

### BRIEF DESCRIPTION OF THE DRAWINGS

The features of the present invention, including the above and other advantages, will be more clearly understood from consideration of the following descriptions in connection the accompanying drawings in which:

FIG. 1 is a block diagram illustrating practice of the invention in a local telecommunication environment having a conventional wireline telephone network and an IP network;

FIG. 2 shows pop-up paging messaging in a data network for locating a called party;

FIG. 3 is a high-level process flow diagram showing the steps of the example of the use of the invention of FIGS. 1 and 2; and

FIG. 4 is a block diagram illustrating an example of the use of the invention in a local telecommunication environment with integrated voice and data IP capabilities.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the invention.

An example of the use of the invention is shown in FIG. 1. A telecommunication environment 10 is shown, such as commonly exists in an office, which has both a voice network in the form of a POTS network 12 and an IP network 14, for example a Virtual Local Area Network (VLAN), which provides a data network for sharing network resources (printers, files, etc.) among users. In the present example of the system 11 of the invention, an outside calling device 20, referred to generally as “caller” 20, calls into the POTS network 12 and is connected to a Private Branch Exchange (PBX) 22 serving the office location. The call may be routed, according to the POTS network 12 in this example, to a telephone receptionist using a voice telephone 23. Of course, it will be clear to those skilled in the arts that the telecommunication environment 10 could be configured in many different ways, using for example, an interactive voice response (IVR) unit instead of a voice telephone 23 to field incoming calls.

Upon learning the intended destination of the call at device 23, the call may be placed in a park queue 24 and be assigned a position in the queue 26. In this example, the telecommunication environment 10 utilizes concurrent POTS 12 and IP network 14 hardware similar to many modern office environments. A server 27 is preferably used to broadcast a paging message 28(a . . . n) to the IP nodes in the IP network 14. It should be understood that server 27 or any suitable voice-data interface known in the arts may be used. In some applications, it may be preferable to also provide capabilities for converting analog voice signals to digitized voice data and vice versa. This would be appropriate in a network environment where voice is handled in the digital domain, such as VolP.

The IP nodes, or data terminals, in this case PC terminals 30(a . . . n), receive paging message 28(a . . . n) providing information regarding the identity of the called party and, optionally, other information concerning the person calling and/or the nature of the call. It should be clear that other types of data terminals may be used such as workstations, laptops, notebooks, palm tops, or data-capable telephones. The paging message 28(a . . . n) may of course include a variety of additional information useful within the particular telecommunication environment 10. For example, the paging message 28(a . . . n) includes a voice service node 32(a . . . n) address corresponding to the intended call-recipient at the time of the call.

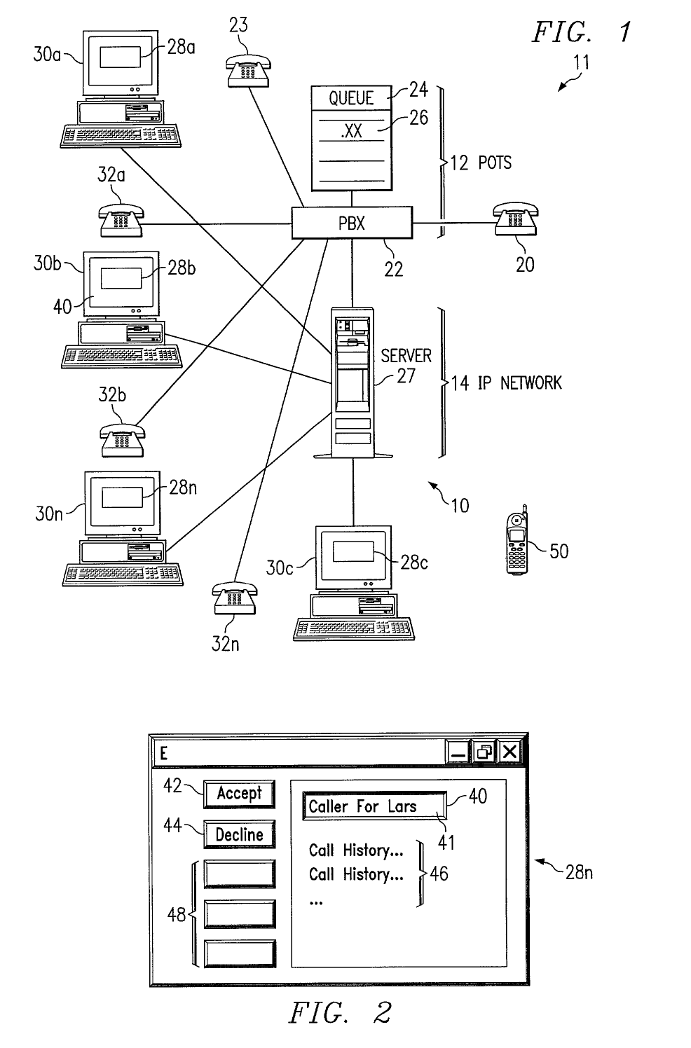

Each terminal 30(a . . . n) may have an associated voice network node 32(a . . . n), in this example a POTS of the type typically found in an office, located in the proximity of the terminals 30(a . . . n). It is known in the art to create an association between a PBX 22, phone extension 32(a . . . n) and a PC terminal 30(a . . . n). For example, a product known as Phonemanager, available from Ericsson Webcom Incorporated, Menlo Park, Calif., may be used for this purpose. Of course, some IP network nodes such as terminal 30(c) may not have an associated telephone network node. By the same token, some telephone network nodes, such as telephone 23, for example, may not have associated IP network nodes. It should also be understood that wireless terminals or wireless telephones may also be included in the telecommunication environment 10 and that the data terminals and voice nodes need not remain static nor need they be restricted to a particular premises. The server 27 accepts input from the IP network terminals 30(a . . . n). The input from the IP network terminals 30(a . . . n) may be in the form of preselected and stored call-routing preferences and/or direct responses to paging message 28(a . . . n). An example of a paging message 28(a . . . n) is shown in more detail in FIG. 2.

In FIG. 2, an example of a pop-up paging message 28(b) system is shown on a PC monitor 40 corresponding to IP network node 30(b). The paging message 28(b) indicates that a call is correctly parked for answer by a called party 41. Menu choices are given in the form of virtual buttons such as, in this example, an “accept” button 42, and a “decline” button 44. Additional information 46 concerning the call such as, for example, call history, account history, and identity of the caller, may also be provided. Optionally, additional features such as storable call-routing preferences may be accessible through additional virtual buttons 48.

Continuing the progress of the example call, the recipient of the paging message 28(b) may choose to accept or decline the call by using buttons 42 or 44, respectively. Of course, the system 11 may be configured to time out, indicating “decline,” after a preset period. In this example, upon an indication of willingness to accept the call by input from the “accept” button 42, the server 27 routes the call from the queue position 46 to the telephone device 32(b) associated with the accepting terminal 30(b). Again referring to FIG. 1, if an “accept” message is received from terminal 30(b), for example, in response to paging message 28(b), the server 27 routes the call from its queue position 26 in the park queue 24 to the telephone device 32(b) associated with the responding terminal 30(b). In this way, the present invention eliminates the need to use an overhead paging system in order to route a call to a called party. Since more and more office environments provide data terminals for every employee, the data network can be used to route incoming calls in the telephone network portion of the office's voice-data system, whether it be a single network or dual network configuration. In this regard, the server 27 provides a voice-data interface between the voice network and data network.

Referring again to FIG. 1, if a paging message 28(c) is received on a terminal 30(c), terminal 30(c) is capable of permitting a user to indicate through input at terminal 30(c), the desired routing for the call. For example, a user may input a telephone number corresponding to another device such as wireless device 50, where routing of the call is desired. This input may be made prior to receiving a call and stored as a routing preference, or may be made in response to a particular paging message. The server 27 then initiates the routing of the call from the queue position 26 to the specified wireless device 50.

According to the invention, a call could be routed to any telephone number or IP address within or outside of the wireline telephone network 12 or IP network 14 of the local telecommunication environment 10. It will be clear to those skilled in the art that the local telecommunication environment 10 can thus be expanded as the particular case requires. This ability to create a “virtual telephone system” is a particular advantage of the invention. For example, the Chief Financial Officer of a corporation could be reached at a wireless telephone 50 on a sailboat as readily as at terminal 30(c) in the office.

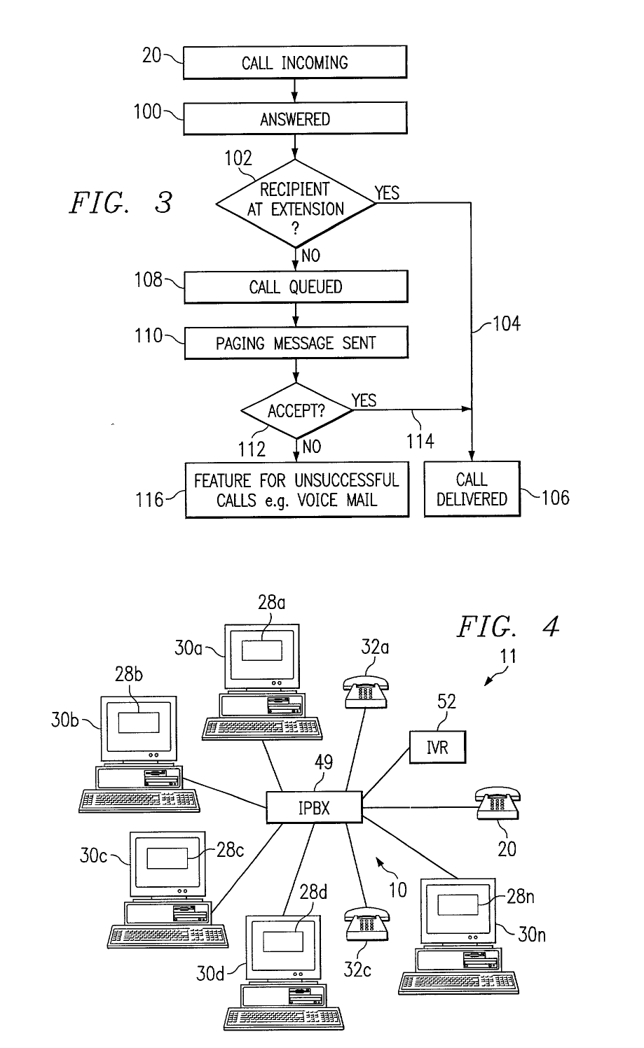

FIG. 3 is a high-level process flow diagram illustrating a method of handling incoming calls according to the invention. It can be appreciated by those skilled in the art that FIG. 3, as illustrated and described herein, presents a self-consistent sequence of steps leading to a desired result. The steps are those requiring the physical manipulation of physical quantities. Usually, although not necessarily, these quantities take the form of electrical or magnetic signals capable of being stored, transferred, combined, compared, and otherwise manipulated.

Further, the manipulations performed are often referred to in terms, such as “routing,” “accepting” or “recognizing”, which are sometimes associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer such as a commercially available Personal Computer (PC) or workstation device running a commercially available operating system such as WINDOWS NT, a registered trademark of the Microsoft Corporation, or other similar devices. In all cases the distinction between the method of operations in operating a computer and the method of computation itself should be borne in mind.

Preferred implementations of the invention can include implementations to execute the method described herein as a program product residing in a memory of microcomputer. Until required by a microcomputer, the set of instructions may be stored as a computer-program product in another computer memory. For example, the set of instructions may be stored as a computer-program product in a disk drive attached to a microcomputer (which may include a removable memory such as an optical disk or floppy disk for eventual use in the disk drive).

Those skilled in the art will appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, operations, or the like, the reader should remember that all of these and similar terms should be associated with the appropriate physical elements.

Thus, in FIG. 3, caller 20 generates a call to a called party at step 100. At step 102, the intended recipient of the call is rung and a determination is made of whether the call is picked up or not. As shown in step 104, if the intended call recipient is in, the call is terminated in the usual way, step 106. In the event the intended recipient of the call does not pick up, the call is queued, as shown in step 108, in a park queue. In step 110, a paging message is then sent to terminals on the data network portion of the local telecommunication environment, for example, a Virtual Local Area Network (VLAN). At step 112, the system evaluates responses to the paging messages sent to the individual terminals. As indicated by path 114, if an “accept” message is received, the call is delivered, preferably using VolP, to the accepting terminal or to another device according to instructions received along with the “accept” message. Step 116 is invoked in the event no “accept” messages are received from any of the paged terminals.

It will be appreciated by those familiar with the arts that there are a number of options for dealing with unaccepted calls, such as voice mail, call forwarding or a return to a human operator. It should also be clear that there are several options for call handling which may be used in connection with the essential aspects of the invention, such as connecting more than one party to the incoming call in the event multiple “accept” messages are received or, for example, allowing an incoming caller menu choices including proceeding immediately to steps 108 and 110, a feature which may be desirable, for example, when calling a recipient who is not expected to be at his or her desk.

The use of the invention 11 in a telecommunication environment 10 having a data network, such as IP network 14, including integrated VolP and IP data capabilities is shown in FIG. 4. In this example, the local telecommunication environment 10, such as an office, is served by an Internet Protocol Public Branch Exchange (IPBX) 49. An outside caller 20 calls into the environment 10 and is connected with the IPBX 49. The caller 20 may be responded to by an Interactive Voice Response (IVR) unit 52, or by a human operator. The IVR unit 52 is a machine which uses a recorded or digitized human voice to provide information to or prompt information input from a caller 20, either through a telephone keypad or voice input. In this example, the caller 20 at some point inputs a desire to speak with a person served by the telecommunication environment 10.

If, for example, the caller 20 indicates a desire to be connected to a person represented in the local telecommunication environment 10 by an IP address representing terminal 28(b) in the data network 14, a paging message 28(b) is sent to terminal 30(b). If an affirmative response is not obtained from terminal 30(b), preferably within a preselected time period, a paging message 28(a . . . n) is sent throughout the data network 14 to terminals 30(a . . . n). The intended recipient of the call, or a deputy, may accept the call, for example, at terminal 30(d). The call is then routed to terminal 30(d), in this example using VolP, and the call is successfully completed. This example is intended to demonstrate the concept of the invention in a local environment 10 with different hardware from that of the example discussed with reference to FIGS. 1-3, showing that the concept of the invention remains unchanged, despite the differences in hardware. As in the example of FIGS. 1 and 2, the essential steps of the method of the invention may be understood in this example with reference to the high-level process flow diagram of FIG. 3.

The present invention achieves technical advantages in selectively routing calls to individuals served by a telecommunication environment in response to receiving information regarding a called party's current location and availability. The invention automatically seeks information regarding possible call routing to reach a particular individual at the time of the call. This is an improvement in the art wherein calls have typically been routed to fixed addresses only, lacking the advantageous methods of the invention for dynamically determining the actual location of a called individual using data network resources, and routing the voice call accordingly.

The embodiments shown and described above are only exemplary. Even though numerous characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

What is claimed is:

1. A system for routing incoming voice calls comprising:
a voice network adapted for receiving incoming calls and routing them to devices associated with called parties;
a data network for sharing data files and networking services; and
a voice-data interface for transmitting a paging message on said data network, accepting a response on said data network, and routing an incoming call to said voice network using the response received on said data network.

2. The system of claim 1 wherein said voice network comprises a Plain Old Telephone Service (POTS) network.

3. The system of claim 1 wherein said voice network comprises a Voice over Internet Protocol (VolP) service network.

4. The system of claim 1 wherein said voice network comprises a wireless network.

5. The system of claim 1 wherein said data network comprises a wireless network.

6. The system of claim 1 wherein said data network comprises a Local Area Network (LAN).

7. The system of claim 1 wherein said data network comprises a Virtual Local Area Network (VLAN).

8. The system of claim 1 wherein said data network comprises a Wide Area Network (WAN).

9. The system of claim 1 wherein said paging message comprises a pop-up window on a PC monitor.

10. In a network supporting both voice and data traffic, a method of utilizing a data terminal to route an incoming voice call in the network comprising the steps of:
receiving a voice call into the network;
parking the incoming call for subsequent routing;
broadcasting a paging message over data terminals of the network;
the data terminals responding to the paging message; and
routing the incoming voice call according to at least one response received from at least one data terminal.

11. The method of claim 10 wherein said responding step comprises referencing a stored call-routing preference.

12. The method of claim 10 further comprising the step of wherein said routing step routes the call to a responding data terminal.

13. The method of claim 10 wherein said routing step routes the call to a device external to the network.

14. The method of claim 10 further comprising the step of associating at least one data terminal of the network with at least one voice service node of the network.

15. The method of claim 14 wherein said routing step routes the call to a voice service node associated with a responding data terminal.

16. In a network supporting both voice and data traffic, computer program product comprising machine-readable instructions for utilizing a data terminal to route an incoming voice call in the network comprising means for:
recognizing the receipt of a voice call into the network;
parking the incoming call for subsequent routing;
broadcasting a paging message over data terminals of the network;
accepting data terminal responses to the paging message; and
routing the incoming voice call according to at least one response received from at least one data terminal.

17. Computer program product according to claim 16 further comprising means for translating calls between analog voice traffic and digital data traffic.

18. Computer program product according to claim 16 further comprising means for associating data terminals with voice service nodes of the network.
